(19) United States
(12) Patent Application Publication
(10) Pub. No.: US 2017/0294099 A1
(43) Pub. Date: Oct. 12, 2017

(54) METHOD FOR DETECTING FLOODS AND SPILLS USING LIFI

(71) Applicants: Melwyn F. Sequeira, Plantation, FL (US); Hubert A. Patterson, Boca Raton, FL (US)

(72) Inventors: Melwyn F. Sequeira, Plantation, FL (US); Hubert A. Patterson, Boca Raton, FL (US)

(73) Assignee: Tyco Fire & Security GmbH, Neuhausen Am Rheinfall (CH)

(21) Appl. No.: 15/210,373

(22) Filed: Jul. 14, 2016

Related U.S. Application Data
(63) Continuation-in-part of application No. 15/139,555, filed on Apr. 27, 2016.
(60) Provisional application No. 62/319,410, filed on Apr. 7, 2016.
(60) Provisional application No. 62/328,579, filed on Apr. 27, 2016.

(51) Int. Cl. G08B 21/10; G06K 9/00; H04N 7/18; G08B 25/10; G01V 8/00

(52) U.S. Cl. CPC G08B 21/10; G08B 25/10; G01V 8/00; H04N 7/183; G06K 9/00744

(57) ABSTRACT

Monitoring a water intrusion condition at a facility comprises using an optical data transceiver to illuminate a monitored interior space with an optical data signal which has been modulated to contain a first data sequence. The optical data transceiver receives one or more retroreflected optical data signals which have been respectively retroreflected in response to the optical data signal. A water intrusion event notification is communicated to an enterprise monitoring controller if a variation occurs in regard to at least one optical beam condition associated with one or more of the retroreflected optical data signals.

### CROSS-REFERENCE TO RELATED APPLICATIONS

This application is a continuation-in-part of U.S. patent application Ser. No. 15/139,555 filed on Apr. 27, 2016 which claims benefit of provisional U.S. Patent Application No. 62/319,410 filed on Apr. 7, 2016, the entirety of which are incorporated herein by reference. This application also claims priority to U.S. Patent Application No. 62/328,579 filed Apr. 27, 2016, the entirety of which is incorporated herein by reference.

### STATEMENT OF THE TECHNICAL FIELD

The inventive arrangements relate to flood detection systems and more particularly to monitoring systems which employ sensors for detecting interior flooding.

### DESCRIPTION OF THE RELATED ART

Facility flood detection systems are well known in the art. Many of today's flood detection systems are either wired or employ battery operated wireless sensors transmitting either in the sub-gig Hz band, such as Z-wave, and the 2.4 GHz band such as Zigbee, Bluetooth and various other technologies. These flood detector systems consist of a flood sensor, a transceiver and processing electronics. The sensors are mainly deployed in basements, around washing machines (dish washer or clothes washer) and around window sills, in residential applications, and warehouses and storage areas in commercial applications to detect the presence of water and an impending flood. A conventional sensor consists of 2 probes connected to the sensing and processing electronics. These probes must come in contact with and must be adequately submerged in a shallow pool of liquid in order to accurately detect the presence of an impending flood. These sensors may be battery powered and wirelessly coupled to an enterprise monitoring station. Alternatively, sensors may be wired sensors that are connected via wired connections to the enterprise monitoring stations.

Conventional flood detection sensors as described herein are almost never deployed in areas experiencing high foot traffic. This limitation is due to the physical size, construction and functional design of conventional sensors which result in the possibility that they could interfere with and cause people to trip and fall from the obstruction they present. While this restrictive approach to the deployment of conventional flood detection sensors minimizes the potential for accidents, it also means that the benefit of flood sensing is not extended to such areas.

Also, since conventional flood sensors are mainly sensitive to and respond to water or liquid, they are almost never triggered by any material obstructing or covering an area. This can be an advantage in many situations, since it prevents false alarms. But this lack of sensitivity to other types of pedestrian obstructions also means that the sensors are not useful for detecting these other types of problematic circumstances. For example, food, debris or other types of material in a pedestrian pathway could go unattended until visibly noticed by a human, or captured by the enterprise's surveillance system. Accordingly, it is not uncommon for at least several minutes to possibly hours to transpire until the enterprise's safety personnel are notified to attend to the scene of such an incident.

Also as explained above, these sensors are “active” devices, in that they are either wired or are battery powered, and hence are susceptible to noise due to environmental disturbances such as RF interference, vibration, lighting strikes etc. The batteries used in wireless sensing systems need to be periodically replaced to ensure a properly functioning sensor, thus putting a strain on serviceability.

### SUMMARY OF THE INVENTION

Embodiments of the invention concern a method and system for optical water intrusion detection and sensing. A system for water intrusion detection is comprised of one or more retroreflectors disposed in a monitored area and an optical transceiver. The optical transceiver includes an optical transmitter unit, an optical receiver unit, and a processor unit. The optical transmitter unit is configured to illuminate at least a portion of the monitored space with an optical data signal which has been modulated to contain a first data sequence. The optical receiver unit is configured to concurrently receive one or more retroreflected optical data signals which have been respectively retroreflected from the one or more reflector elements in response to the optical data signal. The processing unit is configured to receive one or more digital data streams extracted respectively from the one or more retroreflected optical data signals. In some embodiments, the processing unit can determine whether the first data sequence is present therein.

The processing unit also determines an occurrence of a variation in regard to at least one optical beam condition associated with the one or more retroreflected optical data signals. The variation may be a disruption, a displacement, or signal strength variation of a retroreflected optical data signal. The processor selectively generates a water intrusion event notification message if such a variation is detected. Further, the optical transceiver can be configured to function as a wireless network access point, in which case the optical data signal can comprise at least a portion of a management frame defined for a predetermined wireless communication protocol.

Embodiments also concern a method for monitoring a water intrusion condition of a facility. In accordance with the method, an optical data transceiver is used illuminate a monitored interior space with an optical data signal which has been modulated to contain a first data sequence. Thereafter, the optical data transceiver receives one or more retroreflected optical data signals which have been respectively retroreflected in response to the optical data signal. These retroreflected optical data signals are caused by one or more reflector elements disposed in the flood-monitored interior space at one or more locations where intruding water may be present. The method further involves selectively generating a water intrusion event notification to an enterprise monitoring controller if a variation occurs in regard to at least one optical beam condition associated with one or more of the retroreflected optical data signals.

### BRIEF DESCRIPTION OF THE DRAWINGS

Embodiments will be described with reference to the following drawing figures, in which like numerals represent like items throughout the figures, and in which:

FIG. 1 is a conceptual drawing of a flood sensing apparatus that is useful for understanding an embodiment.

FIG. 2 is a conceptual drawing of the flood sensing apparatus in FIG. 1 showing an occurrence of water intrusion associated with flooding.

FIG. 3 is a drawing of a retroreflector element which is useful for understanding an embodiment.

FIG. 4 is a schematic representation of a flood sensing apparatus which is useful for understanding the function and operation of the retroreflector element in FIG. 3.

FIGS. 5A and 5B are drawings respectively showing a first and second video frame in which a captured image includes an optical response of a retroreflector element.

FIG. 6 is a block diagram which is useful for understanding how an optical data transceiver used for flood sensing can be used in connection with a computer data network.

FIG. 7 is a block diagram which is useful for understanding an optical transceiver according to an embodiment.

FIG. 8 is a flowchart that is useful for understanding an embodiment process.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout the specification may, but do not necessarily, refer to the same embodiment.

An improved flood detection/interior fluid intrusion method and apparatus is disclosed herein which makes use of an optical transceiver which can include one or more processing elements, and one or more passive remote sensor elements. According to one aspect, conventional active sensing devices are replaced with one or more totally passive devices which are placed on or embedded into flooring or other surfaces where intruding water may accumulate. These passive devices are responsive to an optical signal from the optical transceiver to communicate status information which may indicate an interior flood event. This flood event status information is received by the optical transceiver using an optical detector element, which can be a video camera, to detect conditions indicative of a flood event in a flood-monitored interior area.

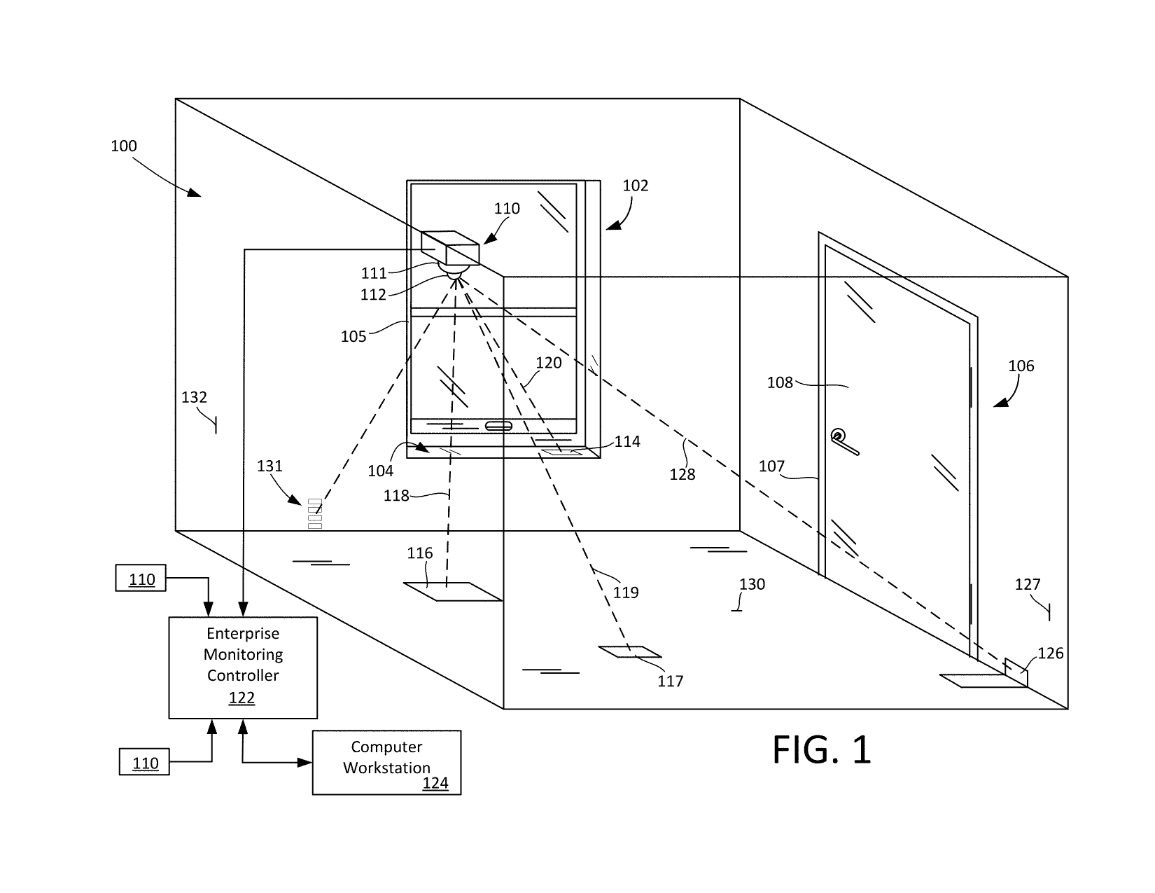

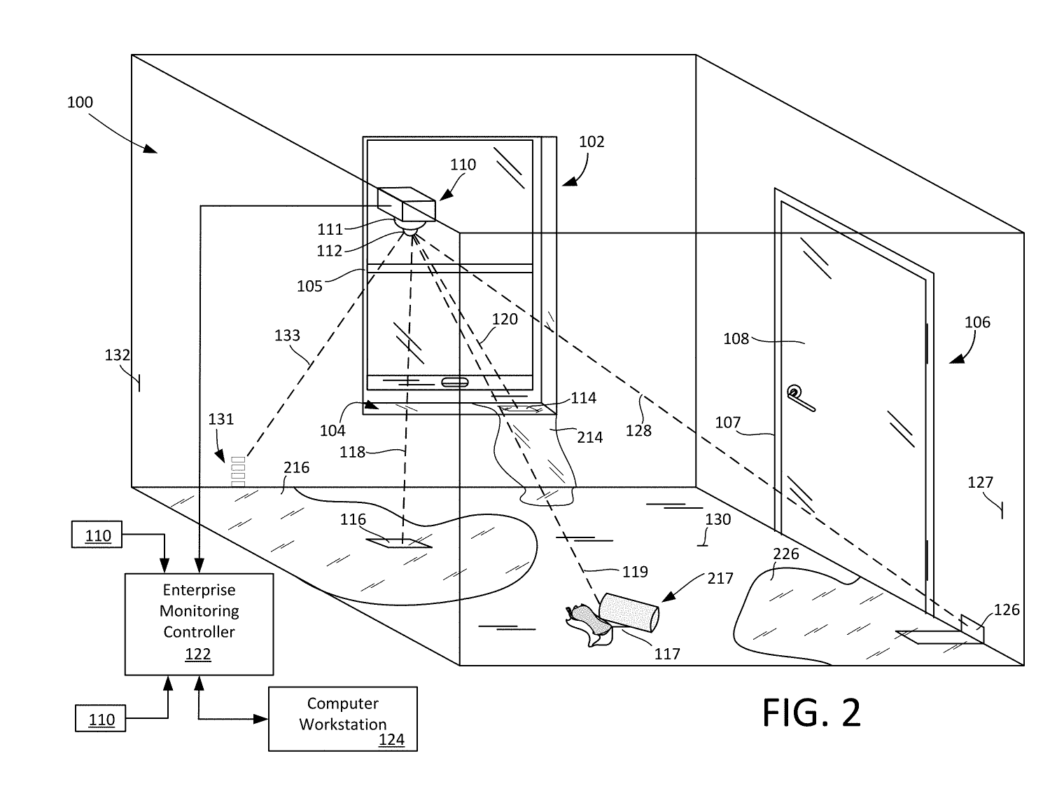

Referring now to FIGS. 1 and 2, a monitored facility 100 can comprise a structure such as an office building, warehouse, or dwelling. As is known, such a construction includes a floor structure 130, and this floor structure may also have any number of different types of floor coverings or finishing defining one or more floor substrates. A construction can also have one or more defined openings such as a window opening 102 and a doorway 106 where water can intrude into an interior space of the facility. The window opening 102 can be defined by a window frame 105 which is supported on a window sill 104. Similarly, the doorway 106 can be defined by a door frame 107 which supports a door, such as door 108. FIG. 1 illustrates a first condition where no water intrusion is present within facility 100. In contrast, FIG. 2 illustrates a second condition where water intrusion into facility 100 has occurred.

The flood-monitored facility 100 is advantageously protected against fluid intrusion/flood events by an enterprise flood detection system which includes an optical sensing system. As used herein, the term flood or flooding can refer to any condition wherein water or other liquids intrude into areas of a facility where it is not normally desired. Accordingly, the term flood or flooding can refer to any undesired accumulation of water or other type of liquid in monitored areas of a facility.

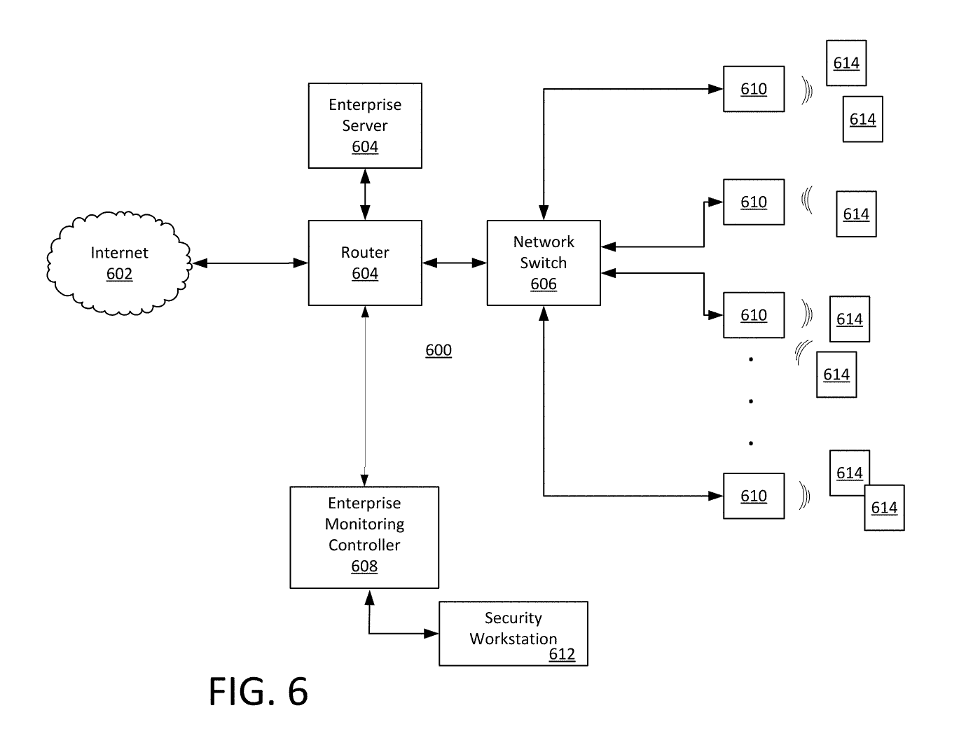

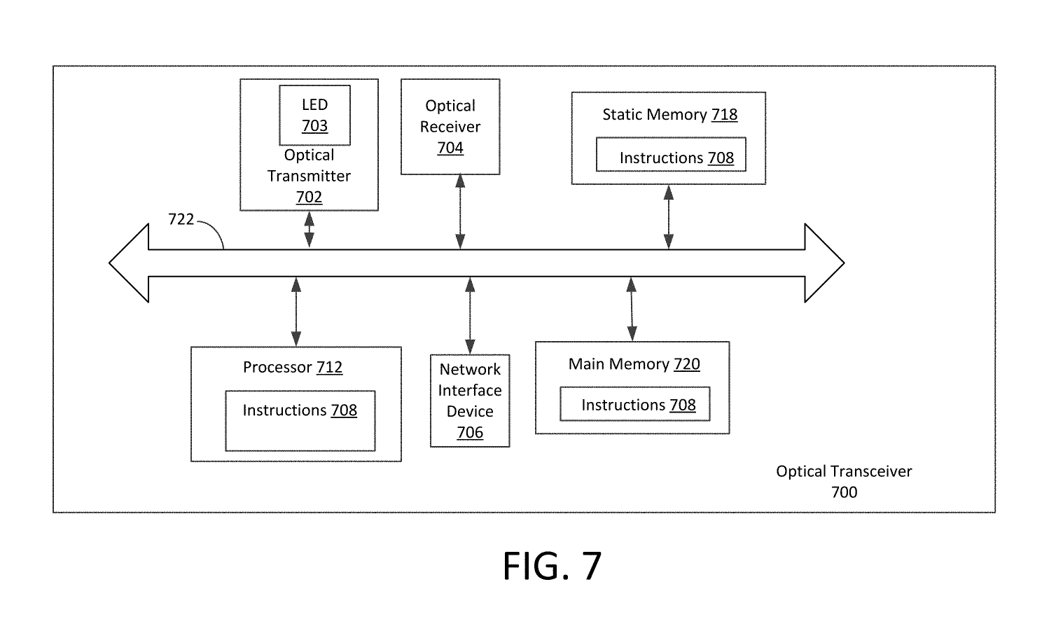

The optical sensing system 100 is comprised of an optical transceiver 110 and one or more reflector elements 114, 116, 117, 126, 131 disposed on or near a floor surface. According to one aspect, one or more of the reflector elements 114, 116, 117, 126, 131 are retroreflectors as discussed below in further detail. A retroreflector is a device or surface that reflects light back to its source with a minimum of scattering. An optical transceiver 110 as described herein comprises an optical source 111 (such as a light emitting diode) and an optical receiver 112 (such as a photodetector or a video camera). In an embodiment the optical transceiver 110 can also include one or more processing elements to perform certain processing functions as hereinafter described. An embodiment optical transceiver is discussed below in further detail in relation to FIGS. 6 and 7. In some embodiments, the optical transceiver 110 can be integrated into a lighting system for the facility contained in the ceiling, such that the same optical radiation used for illuminating a room can also be used for the flood functions described herein.

The reflector elements 114, 116, 117, 126, 131 can be disposed on or embedded into a surface where flooding or water intrusion is likely to occur. Exemplary locations can include floors 130 and surfaces adjacent to or proximate to the floor. Such surfaces can also include wall surfaces 127, baseboards, molding and trim which extend along the wall at a location proximate to a floor. For example, a plurality of reflectors 131 are shown disposed on a wall 132. In some scenarios, the reflectors can be disposed on a floor 130 and an adjacent wall 127. For example, reflector 126 is shown disposed on both the floor 130 and the vertical surfaces defined by adjacent wall 127. The reflector elements can also be disposed on window sills 104 or adjacent to doorframes 107 where water intrusion is likely to occur. Of course, embodiments of the invention are not limited in this regard and other reflector locations are also possible.

According to one aspect, the rate of change of the flood depth (when water is rising or receding) can be determined using the reflectors mounted on walls, baseboards, and other similar structures. This concept is best understood with reference to reflectors 131 shown in FIGS. 1 and 2. It can be observed therein that a plurality of reflectors 131 are arranged on a wall 132 at varying distances above the floor 130. The reflectors 131 are shown stacked in vertical alignment in FIGS. 1 and 2, but it can be advantageous to instead arrange such reflectors so that they are not in vertical alignment (i.e. the reflectors are laterally offset) to better differentiate which sensor is generating a retroreflected optical beam at a receiver. In either case, a varying number of the reflectors 131 will be exposed as the level of intruding water 216 rises and falls. And the varying number of reflected beams can be detected for water depth monitoring.

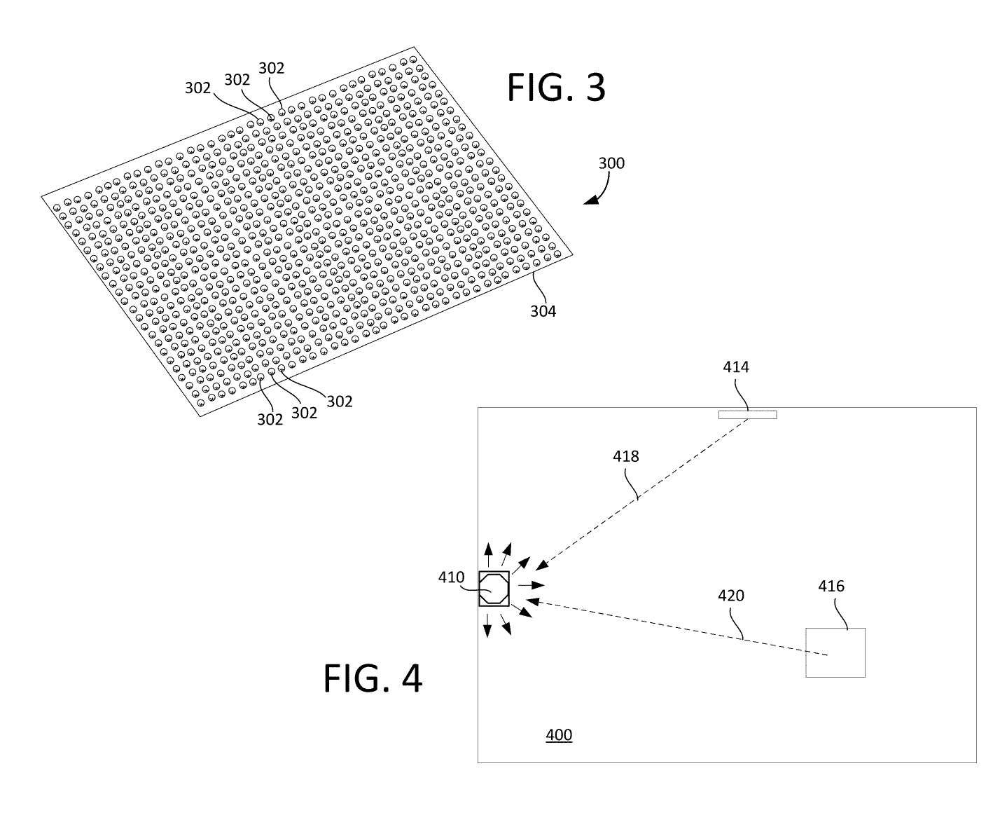

Referring now to FIG. 3, there is shown an exemplary reflector element 300 which is useful for understanding the invention. In an embodiment, the reflector element 300 is a retroreflector, meaning that it reflects light directly back to its source with a minimum of scattering. Retroreflectors can be implemented in various ways and the exact construction of the retroreflector is not critical for purposes of the present invention. However, an exemplary reflector element 300 can be comprised of a plurality of transparent optical beads or microspheres 302. Accordingly, under normal conditions (absent of flooding) an optical wave which arrives at the reflector element 300 in a first vector direction is reflected back along a second vector direction that is parallel to but opposite to the transmit vector direction. The microspheres can be secured or embedded in a binder material 304 in a random or predetermined pattern. The binder material 304 can be a colorless clear paint, a flexible substrate in the form of a tape with adhesive disposed on one surface to secure the tape to a surface, or any other suitable material that is capable of securing the microspheres in a location.

As is known, a transparent optical microsphere which is designed to be a retroreflector can be achieved when the microsphere is made from a material having a particular refractive index. The refractive index selected for this purpose is approximately one plus the refractive index nᵢ of the medium surrounding the microsphere from which the optical radiation is incident. The index of refraction of air is approximately 1 for air; so the index of refraction chosen for transparent optical microspheres is usually selected to be between 1.5 up to around 1.9. Accordingly, transparent optical microspheres used for retroreflection herein can have an index of refraction in this range. In some scenarios, it may be desirable to design a retroreflector so that a reflected signal is communicated (retroreflected) back to the optical transceiver when the retroreflector is immersed in a liquid (e.g. water). In such scenarios, transparent optical microspheres having a different index of refractions may be selected to facilitate retroreflection. In general, transparent optical microspheres with an index of refraction in the range of 2.3 to 2.7 are quite capable of retro-reflectivity, even under water. However, the retroreflection problem is considerably more complicated in such scenarios as it is also necessary to consider refraction which occurs at the air-water boundary.

An embodiment is illustrated in FIG. 4 which shows an optical source 410 and reflector elements 414, 416 which are retroreflectors disposed in a three-dimensional space. The optical source 410 has an omnidirectional optical source pattern and can illuminate the three-dimensional space 400. The omnidirectional optical source pattern is indicated by a plurality of vector arrows in FIG. 4 which show that optical radiation from the optical source 410 is transmitted in all directions from the source. As shown in FIG. 4, the transmitted optical radiation which is incident upon the reflector elements 414, 416 is reflected back (in the absence of flooding) to the source in a vector direction 418, 420 which is parallel but opposite to the vector direction of the incident optical radiation. So when the optical source 410 illuminates one of the reflector elements 414, 416, the reflected light will be directed towards the optical source and any associated optical receiver rather than in all directions as would occur with diffuse reflection. Liquid intrusion which covers the retroreflector will cause a disturbance in the reflected light. The disturbance can involve an elimination of the reflected signal, or can result in an angle of reflection which is different for the reflected signal as compared to conditions in the absence of flooding. These disturbances can be detected by the transceiver 110 and used to determine the presence of flooding or liquid intrusion.

An advantage of the retroreflectors described herein is that these are passive devices and hence require no power to engage in communications with the optical transceiver 110. The modulated optical signal transmitted from the optical transceiver is reflected right back from these retroreflectors to the optical source, thus making these passive receivers virtually a permanent part of the structure.

Referring once again to FIGS. 1 and 2, a modulated optical signal is transmitted from the optical source 111 to illuminate at least a portion of the monitored facility 100. The optical source and optical receiver can be substantially co-located as shown in FIGS. 1 and 2. Consequently, the modulated optical beam from the source can be retro-reflected by one or more of the reflector elements 114, 116, 117, 126, 131 back to the optical receiver 112. The optical receiver 112 detects the reflected modulated optical signal 118, 119, 120, 128, 131 and performs certain processing operations on the received signal. According to one aspect, one or more processing elements provided in the optical transceiver 110 are used to demodulate or process the received optical signal to extract data or information embedded in the modulated signal. The extracted data is then compared with the modulated data contained in the signal that was transmitted by the optical source 111 to verify that the received optical signal is in fact a reflection of the transmitted signal. This verification step helps to prevent the optical transceiver 110 from generating false alarms caused by ambient light from other sources and/or intentional efforts to spoof the flood system.

According to one aspect of the invention, a reflected optical signal from one or more of the reflector elements 114, 116, 117, 126, 131 is monitored by a processing element (e.g. a processing element associated with the optical transceiver 110). Disturbances associated with the reflected optical signal are then analyzed to determine if a flood event has occurred. Such a disturbance is illustrated in FIG. 2, which shows that a liquid 214, 216, 226 (such as water) has covered one or more reflector elements 114, 116, 117, 126, and 131.

In the simplest case, a disturbance associated with a reflected optical signal can comprise an interruption or disruption of the reflected signal such that the presence of the reflected signal is no longer detected at the optical transceiver 110. As an example, such an interruption in the reflected optical signal could occur when retroreflectors disposed on or near a floor surface become immersed in water or other fluids which prevent an occurrence of a reflected signal. When the retroreflectors are covered with cloudy water or other fluids which are opaque or nearly opaque, the optical signal from the transceiver is obstructed. This obstructing effect prevents the transmitted data stream from being reflected back to the optical transceiver 110.

In the event that the water or other fluid covering the retroreflectors is clear or has a degree of translucence it is possible (although unlikely) that a retroreflected modulated optical signal can still potentially be detected at the transceiver 110. In such scenarios, the change in the index of refraction associated with the water or other fluid covering the retroreflectors can change a vector angle of a reflected modulated optical signal as it traverses an interface between the liquid and surrounding air. Consequently, the optical transceiver 110 can detect that disruption or change in the reflected optical signal has occurred. The disruption or change is then analyzed to determine if the conditions are indicative of a flood event. If a flood event is determined, a flood event notification is transmitted to an enterprise monitoring controller 122 (e.g. a computer server).

A disruption can involve the optical signal being interrupted or redirected so that it no longer is detected at the optical transceiver. A disruption can also include a displacement of the received optical signal. A disruption can also involve a change in the nature of the optical signal strength or intensity of the optical signal being received. In a scenario where the optical transceiver 110 is monitoring only a single reflected optical signal (e.g., from a single reflector element 116), a simple solid state photo detector provided in the optical transceiver can be used to receive the reflected optical signal. An associated processing element monitoring the output of the solid state photodetector can then detect the interruption or disruption of an optical signal as described herein.

A solid state optical detector element can be sufficient for monitoring a reflected optical signal from a single reflector element. But for purposes of monitoring a plurality of reflector elements 114, 116, 117, 126, 131 the optical receiver 112 associated with the optical transceiver is advantageously a video camera. Use of a video camera as the optical receiver 112 can facilitate concurrent monitoring of reflected optical signals from a plurality of reflector elements by a single optical transceiver 110.

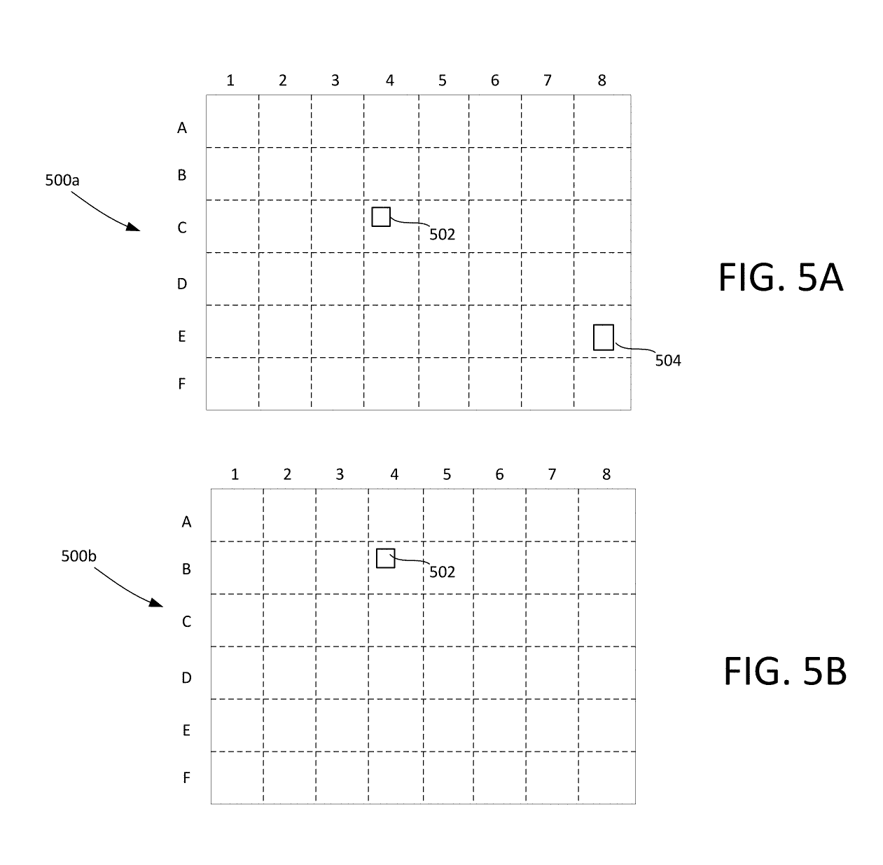

An optical receiver (such as optical transceiver 112) which comprises a video camera can capture one or more video frame images. In an arrangement as described with respect to FIGS. 1 and 2, the video camera can capture video frame images which include reflected optical signals (e.g., reflected modulated optical signals 118, 119, 120, 128, 133). This concept is illustrated in FIGS. 5A and 5B which respectively show a first video frame image 500a captured at a first moment in time, and a second video frame image 500b captured at a later moment in time. As an aid to understanding the invention, grid lines in the first and second video frame images are used to delineate a plurality of rows A through F and a plurality of columns 1 through 8.

In the first video frame image 500a, modulated optical signals 502 and 504 are detected within the frame. More particularly, reflected modulated optical signal 502 from a first retroreflector element (not shown) activates pixels in a frame portion C-4 (i.e., where row C and column 4 intersect). Similarly, modulated optical signal 504 from a second retroreflector element (not shown) activates pixels in frame portion E-8. An electronic processing element associated with optical transceiver 110 can identify or isolate the activated pixels which are associated with each reflected modulated optical signal, and process the optical signal received by those pixels to independently extract modulated data from each signal 502, 504. Accordingly, the optical transceiver 110 can concurrently independently monitor a position and/or intensity of a plurality of reflected modulated optical signals. Data can be extracted from each signal to verify that it is a reflection of a transmitted signal originating from the optical transceiver 110 (or an adjacent optical transceiver).

In the second video frame image 500b captured at a later time, it can be seen that reflected modulated optical signal 504 has been disrupted entirely such that it is no longer present in the captured frame. This disturbance or disruption in the reflected modulated signal 504 can be detected by a processing element. Reflected modulated optical signal 502 has been displaced (moved position) within the frame from C-4 to B-4. The displacement or change in relative position of the modulated optical signal 502 in frame 500b as compared to 500a is an indication that a disturbance or disruption has occurred with respect to modulated optical signal 502. For example, such disturbance can involve the presence of a layer of a liquid which has covered a retroreflector, such that its angle of reflection has changed slightly in the return path to the transceiver. This disturbance in modulated optical signal 502 can also be detected by a processing element.

The processing element can also detect disruptions in the intensity of an optical signal associated with each reflected modulated optical signal captured by the video camera. Similarly, if reflected modulated optical signals 502, 504 are detected in first frame 500a, but only signal 504 was detected in a second frame, the absence of signal 502 can be attributed to some action which interrupted modulated optical signal 502. For example, such interruption might be caused by interior flooding, as shown in FIG. 2, which disrupts a reflected signal from reflector element 114, 116, 126. A processing element associated with optical transceiver 110 can detect one or more such occurrences and use them to selectively trigger an event notification to an enterprise monitoring controller 122.

Alternatively, the interruption in the reflected signal could be attributed to a person, animal or object temporarily obstructing a reflected optical beam originating at or near the floor level. Such a scenario is also shown in FIG. 2, where items of refuse or trash 217 have been discarded on the floor so as to cover a retroreflector 117. The refuse 217 continually disrupts reflected beam associated with a modulated optical signal 119. A processing element associated with optical transceiver 110 can detect such disruption and use such occurrence to selectively trigger an event notification to an enterprise monitoring controller 122.

Changes or disruptions in the optical signals captured in a video frame can be detected by comparing an image frame to an earlier capture image stored in a database. The image comparison functions described herein can be performed by a processing element associated with the optical transceiver or in an enterprise monitoring controller. If the optical receiver is a video camera, the detection of a disturbance or variation in the reflected modulated optical signal can also be used to trigger one or more video image frames to be stored in a memory location in the optical transceiver 110. The captured video frame image can then be communicated to the enterprise monitoring controller together with the event notification. Accordingly, a video record or the activities associated with the event notification can be retrieved for later inspection.

Persons passing through the facility 100 can potentially trigger false water intrusion alarms if their presence causes a disruption in one or more of the retroreflected optical signals. In order to avoid such false water intrusion alarms, one or more characteristics of a received retroreflected optical signal can be averaged, integrated or otherwise processed over a period of time, and the results can be compared to one or more threshold values. The goal of such filtering would be to filter out brief, momentary disruptions which are unlikely to be attributable to water intrusion. Consequently, a momentary interruption in a retroreflected optical beam caused by a person walking through the room can be prevented from generating a false water intrusion alarm.

When a flood event notification is generated, the notification can include data specifying the location of the optical transceiver 110. The event notification can also specify a particular door, window or floor location in the monitored facility where a disturbance has been detected with regard to a reflected modulated optical signal. The foregoing step can require a learning or training process in which reflected modulated optical signals that are associated with particular windows, doors or locations are identified to the optical transceiver 110. Thereafter, any event notification communicated to an enterprise monitoring or management controller concerning a particular reflector element can include metadata which specifies the door, window or floor location where the flood event was detected.

For example, during a training period a modulated optical signal 504 could be assigned a metadata tag indicating that it is associated with the door to a particular first office, room or corridor. Modulated optical signal 502 could be assigned a metadata tag indicating it is associated with a window outside, within or adjacent to the first office, room or corridor. Once the tags have been defined in this way, a subsequent disturbance of a reflected modulated optical signal associated with such tag can generate an event notification including metadata to specify the location where a flood event was detected.

In an embodiment, an optical transceiver as described herein can comprise a wireless access point of a data network. As such, the optical transceiver can use an optical part of the electromagnetic spectrum to facilitate wireless communications with one or more network devices which may be present in a monitored facility, and other components of a data network. For example, the optical transceiver can use the same optical source and optical receiver for wireless access and flood sensing operations as described herein. According to one aspect, each optical transceiver can comprise a Li-Fi wireless network access point. As is known, Li-Fi is a bidirectional high speed and fully networked wireless communication technology. Li-Fi is similar to Wi-Fi and uses IEEE 802.15.7 protocols, but offers higher data rates. Li-Fi uses radiation in the optical wavelength range to facilitate such wireless communication. For example, Li-Fi can be implemented using light in the visible, infra-red, and near ultra-violet range.

An embodiment as described above is illustrated in FIG. 6 which shows that a flood-monitored facility 600 may include a plurality of optical transceivers 610. Each optical transceiver 610 is arranged to monitor a portion of the facility using reflector elements in a manner similar to that described herein with respect to FIGS. 1-5. Each optical transceiver 610 is also wireless access point of a data network 600 which utilize an optical part of the electromagnetic spectrum to wirelessly communicate with one or more client network devices 614 which may be present in the flood-monitored facility.

According to one aspect, the same optical signals used for optical wireless data network communications can be used for optical flood sensing as described herein. For example, Li-Fi wireless access points will periodically generate certain types of management frames which are used to allow for the maintenance of communications. One such management frame is known as a beacon frame. The beacon frame is used to periodically announce the presence of the wireless access point. It typically contains source and destination media access control (MAC) addresses, its service set identifier (SSID), a timestamp, and other parameters of interest to wireless network devices seeking to communicate through the access point. A common default beacon interval is about once every 100 milliseconds.

An optical transceiver which is used for flood sensing as described herein can transmit its beacon frame in a conventional manner. The optical transceiver can then compare the information contained in a transmitted beacon frame to data contained in a received optical signal to determine whether the received signal is a reflected modulated signal. If so, the reflected modulated signal derived from the beacon frame can be used for flood sensing purposes as disclosed. The reflected beacon frame signal can also be used to detect flooding or water intrusion using the techniques described herein. Of course, other signals communicated as part of the data network operation can also be used for flood sensing without limitation. Further, it should be appreciated that in some scenarios, dedicated optical signals for flood sensing can be used to facilitate the sensing functions described herein. Such dedicated flood sensing optical signals can be transmitted and received using the same optical source and receiver as used with the data network functions, but would be exclusively used for flood sensing purposes. For example, the modulated optical data signal from the optical transceivers could include the location (coordinates) of the optical transceiver source, the occupant of the office and/or those authorized to enter a monitored area, and various other attributes specific to the area being monitored for water intrusion.

As shown in FIG. 6, the computer network 600 can include a network switch 606 for switching data communicated to and from the various optical transceivers 610, a router 604, and one or more servers 604 to facilitate enterprise level network operations. An enterprise monitoring controller 608 (which may be a computer server) can also be connected to the network 600. Communication from the optical transceivers 610 to an enterprise monitoring controller 608 can be facilitated by the router 604. The router can also facilitate network data access from the optical transceivers 610 to the internet 602 as shown.

Referring now to FIG. 7, there is shown a block diagram of an exemplary optical transceiver 700 in accordance with the inventive arrangements. The optical transceiver is configured to perform flood sensing functions as described herein. The optical transceiver 700 can also comprise a wireless optical access node for a data network. For example, the optical transceiver can comprise a Li-Fi type wireless optical data access node operating in accordance with a standard IEEE 802.15.7. Accordingly, one or more hardware elements which are used to facilitate Li-Fi type wireless optical data communications can also function to facilitate the flood sensing functions described herein. Further, the same optical signals which are communicated by the optical transceiver 700 to facilitate wireless network access functions can also be used for the flood sensing functions described herein.

Referring now to FIG. 7, an optical transceiver system 700 includes a processor 712 (such as a central processing unit (CPU), a graphics processing unit (GPU, or both), a main memory 720 and a static memory 718, which communicate with each other via a bus 722. The system 700 can further include an optical transmitter 702 (which can comprise an LED 703 and associated LED driver circuitry), and an optical receiver 704 which can be in the form of a video camera and/or a photo detector depending on the particular implementation. The optical transceiver system 700 can also include a network interface device 706 to facilitate communications with one or more network infrastructure components of a local area network (e.g. network 600) using a computer data network communication protocol. The network interface device 706 can be configured to facilitate a wired or wireless connection to the data network.

The output of the optical transmitter 702 is under control of the processor 712. For example, the processor 712 can control the optical transmitter 702, optical receiver 704 and network interface device 706 to facilitate flood sensing operations as described herein. The processor 712 can also perform processing operations in support of such flood sensing operations as described herein. In some embodiments, the processor can cause the optical transmitter 702 to output a data modulated optical output signal which is exclusively used for flood sensing operations as described herein. In other embodiments, the processor 712 can also facilitate a wireless optical access point function. In such a scenario, the processor can utilize optical transmitter 702, optical receiver 704 and network interface device 706 to provides client devices (e.g. devices 614) with wireless optical access to a data network (e.g. a network 600). In that case, one or more transmitted signals used to facilitate the wireless optical access point functions can also be used by the processor 712 to facilitate optical flood sensing as described herein. According to a further aspect, the at least one LED provided in the optical transmitter 702 can be configured to concurrently or simultaneously perform at least a dual function. The dual function can include (1) generating the optical data stream (e.g., for wireless network access and flood detection) and (2) illuminating the room for human occupants of a monitored space. The room illumination function can be facilitated by selecting the LED to have (1) a wavelength corresponding to the visible light spectrum and (2) a lumen output corresponding to illumination levels which are suitable for human occupants in accordance with applicable building standards. Concurrent or simultaneous operation can be achieved by modulating the LED output at a rate that is not visible to the human eye so that illumination and data stream functions are carried out at the same time.

If the optical transmitter serves a dual function of generating the optical data stream and illuminating the room for human occupants, it can be desirable to dim or suspend the light output from the LED during certain times (e.g. at night when a monitored facility is closed for the evening). It will naturally be desirable to continue flood sensing operations during such times and to facilitate continued monitoring under such conditions. Accordingly, the lumen output of the LED can be reduced at such times to suitable nighttime levels so that the light output perceived by the human eye is negligible. But the light output is advantageously controlled so that it remains sufficient to facilitate flood monitoring and/or network data access functions as described herein. In some embodiments, this can involve performing flood sensing operations using the reduced lumen output of the LED. In other embodiments, the LED lumen output can be momentarily increased to some extent (e.g. to full power) to facilitate flood monitoring, but the duration of such increased lumen output can be precisely controlled to very short pulses so that it is imperceptible or appears to humans as a minimal lumen output. Accordingly, reflectors will be illuminated (albeit at a much lower light level) and the reflected optical signals will still be monitored by the optical receiver 704. Of course, the foregoing assumes that the same LED is used to for room illumination (for visibility) and for flood sensing. A further alternative embodiment would involve using an LED for flood sensing which has a light output in a wavelength range which is outside human perception (e.g. infrared spectrum). In some scenarios, a plurality of different LED's having different characteristics can be used to facilitate the various functions described herein.

In the optical transceiver 700, the main memory 720 is comprised of a computer-readable storage medium (machine readable media) on which is stored one or more sets of instructions 708 (e.g., software code) configured to implement one or more of the methodologies, procedures, or functions described herein. The instructions 708 can also reside, completely or at least partially, within the static memory 718, and/or within the processor 712 during execution thereof by the computer system. Those skilled in the art will appreciate that the optical transceiver system architecture illustrated in FIG. 7 is one possible example of such a system, but is not intended to be limiting in this regard. Any other suitable optical transceiver system architecture can also be used without limitation. Dedicated hardware implementations including, but not limited to, application-specific integrated circuits, programmable logic arrays, and other hardware devices can likewise be constructed to implement the methods described herein. Applications that can include the apparatus and systems of various embodiments broadly include a variety of electronic and computer systems. Some embodiments may implement functions in two or more specific interconnected hardware modules or devices with related control and data signals communicated between and through the modules, or as portions of an application-specific integrated circuit. Thus, the exemplary system is applicable to software, firmware, and hardware implementations.

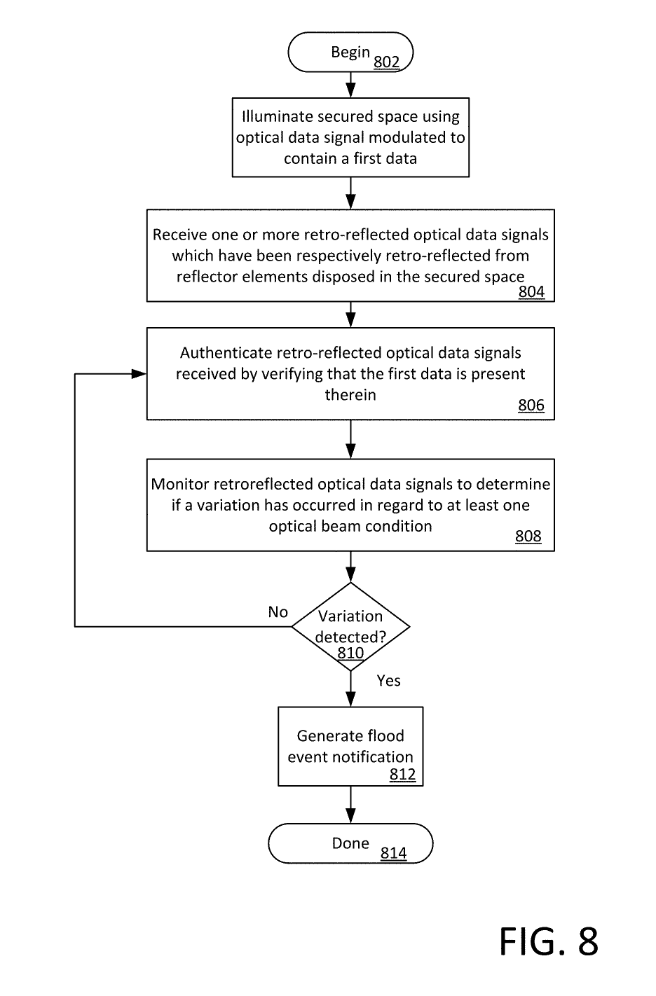

Referring now to FIG. 8 there is provided a flowchart that is useful for understanding an embodiment process. The process begins at 800 and continues at 802 where an optical transceiver is used to illuminate a monitored space using an optical data signal modulated to contain a first data. As used herein, illuminate should be understood to mean transmitting or broadcasting the optical signal into a monitored space and may or may not involve illuminating the room to in the conventional sense to facilitate visibility for users. The process continues at 804 where one or more retroreflected optical data signals are received at the optical transceiver. As noted above, the retroreflected optical data signals are optical signals originating from the optical transceiver, but have been retroreflected from a plurality of reflector elements disposed in the monitored space.

At 806, authentication of the plurality of retroreflected optical data signals can be performed. This step can be implemented to verify that the received optical data signals are in fact retroreflected optical data signals that originated from the optical transceiver. The authentication step can involve verifying that a first data sequence contained in the transmitted optical data signal is identical to a second data sequence contained in the received optical data signal. The authentication step can help prevent spoofing of the flood detection system by bogus optical signals and can be used to filter optical reflections produced from other optical sources.

The process continues at 808 by monitoring the retroreflected optical data signals to determine if a variation has occurred in regard to at least one optical beam condition. Such optical beam condition can involve an interruption of a retroreflected optical beam (i.e., the beam is no longer detected) of the retroreflected optical beam. However, the variation can also comprise a displacement or substantial variation in the detected intensity or optical signal strength. The displacement can involve a displacement of the optical beam as described herein with respect to FIGS. 5A and 5B.

Based on such monitoring, a decision is made at 810 as to whether a variation has been detected. If not (806: No), then the process returns to 806 and 810 for continued authentication and monitoring. But if a variation is detected (806: Yes) a flood event notification is selectively generated to an enterprise monitoring controller. In a scenario, wherein several sensors 131 are arranged at different levels relative to a floor, the flood event notification can include an indication of the water depth based on a determination of which reflectors have been affected by the rising or falling water level.

One advantage of a flood sensing system described herein derives from the fact that the optical data signal transmitted by the optical transceiver is modulated to contain a particular data sequence. The presence of the data sequence allows the optical transceiver to authenticate a received optical signal to determine whether it is a retroreflected optical data signal. This authentication process can involve comparing a data sequence in the received signal optical signal to the transmitted optical signal to determine whether the same data sequence is present in each. But in some scenarios, a person attempting to spoof a flood sensing system may try to do so by using an optical jammer. For example, such persons could attempt to overpower the optical receiver with a higher powered beam of light. Alternatively, they might use an optical receiver to detect the transmitted optical beam and then independently generate a new optical beam which actually contains the particular data sequence contained in the optical beam transmitted by the monitoring system.

To overcome this potential issue, the processing components of the optical transceiver described herein can apply further authentication criteria. For example, the processing components can compare a timing of a modulated data stream in a received optical signal to a timing of the modulated data signal in the transmitted modulated optical data signal. A timing of a modulated data sequence in an authentic retroreflected optical data signal should be delayed only a very small duration of time relative to the modulated data sequence in a transmitted optical data signal. If the delay exceeds a predetermined threshold, then the received optical signal can be rejected as non-authentic.

Further, the optical transceiver in response to detecting a jamming signal or a non-authentic optical data signal, can perform certain countermeasure actions. For example, if a video camera is used as the optical receiver, then the wavelength of the received optical signal (jamming signal and/or non-authentic optical data signal) can be determined or approximated. In such scenarios, the processor can cause the optical transceiver to selectively transition to another wavelength so that the transmitted modulated optical data signal illuminates the flood sensing area using optical radiation having an alternate optical wavelength. The alternate optical wavelength can be in a portion of the visible, infrared or near ultraviolet spectrum which is different as compared to that previously in use by the system. For example, if the optical transceiver system were to detect a significantly high level of light in the 530 nm (green) or 630 nm (red) wavelengths, the transceiver can dynamically shift its dominating transmitting and receiving frequencies to a less sensitive wavelength such as 430 nm (blue), thus preventing the monitoring system from being defeated. According to a further embodiment, the optical transceiver can be caused to periodically hop at a rapid rate among a plurality of different optical wavelengths to thwart attempts at spoofing the system. If a received optical data signal has the wrong wavelength at a particular moment in time, then it can be determined to be a non-authentic retroreflected optical data signal on that basis alone.

Although the invention has been illustrated and described with respect to one or more implementations, equivalent alterations and modifications will occur to others skilled in the art upon the reading and understanding of this specification and the annexed drawings. In addition, while a particular feature of the invention may have been disclosed with respect to only one of several implementations, such feature may be combined with one or more other features of the other implementations as may be desired and advantageous for any given or particular application. Thus, the breadth and scope of the present invention should not be limited by any of the above described embodiments. Rather, the scope of the invention should be defined in accordance with the following claims and their equivalents.

1. A method for monitoring a water intrusion condition of a facility, comprising:
using an optical data transceiver to illuminate a monitored interior space with an optical data signal which has been modulated to contain a first data sequence;
concurrently receiving at the optical data transceiver one or more retroreflected optical data signals which have been respectively retroreflected in response to the optical data signal from one or more reflector elements disposed in the flood-monitored interior space at one or more locations where intruding water may be present; and
selectively generating a water intrusion event notification to an enterprise monitoring controller if a variation occurs in regard to at least one optical beam condition associated with the one or more retroreflected optical data signals.

2. The method according to claim 1, wherein the variation is selected from the group consisting of a displacement, a disruption, or a change in signal strength of one or more of the retroreflected optical data signals.

3. The method according to claim 1, further comprising authenticating the one or more retroreflected optical data signals by determining whether the first data sequence is present therein.

4. The method according to claim 1, further comprising using the optical data transceiver to facilitate wireless network access to a computer data network.

5. The method according to claim 2, further comprising using the computer data network to communicate the water intrusion event notification to the enterprise monitoring controller

6. The method according to claim 1, further comprising selecting the first data sequence to comprise at least a portion of a management frame defined for a predetermined wireless communication protocol.

7. The method according to claim 6, selecting the management frame to be a beacon frame.

8. The method according to claim 1, further comprising receiving the one or more retroreflected optical data signals at the optical transceiver by using a video camera.

9. The method according to claim 8, wherein the variation comprises a displacement of at least one of the retroreflected optical data signals, and the displacement is detected by comparing a first video image frame captured at a first time to a second video image frame captured at a second time subsequent to the first time.

10. The method according to claim 9, wherein the comparing comprises comparing a first pixel location within the first video image frame where the at least one retroreflected optical data signal is detected at the first time to a second pixel location within the second video frame where the at least one optical beam is detected at the second time.

11. The method according to claim 1, further comprising disposing the one or more reflector elements on a floor surface.

12. The method according to claim 1, further comprising disposing the one or more reflector elements on a surface positioned approximately perpendicular to a floor surface.

13. The method according to claim 1, further comprising authenticating the one or more retroreflected optical data signals by comparing a first optical wavelength of the retroreflected optical data signal to a second wavelength of an optical data signal transmitted into the monitored space.

14. The method according to claim 1, wherein the optical data transceiver includes at least one light emitting diode (LED) and the method further comprises using the at least one LED for at least a dual purpose which includes generating the optical data signal and illuminating the room to facilitate visibility for human occupants.

15. The method according to claim 1, further comprising selectively varying at least one of a lumen output level and a duty cycle of the at least one LED to accommodate water intrusion sensing operations during periods when the illumination to facilitate visibility for humans occupants is not needed.

16. An optical data transceiver, comprising:
an optical transmitter unit configured to illuminate at least a portion of a monitored space with an optical data signal which has been modulated to contain a first data sequence;
an optical receiver unit configured to concurrently receive one or more retroreflected optical data signals which have been respectively retroreflected in response to the optical data signal from one or more reflector elements disposed in the monitored space; and
at least one processing element which is configured to:
receive one or more digital data streams extracted respectively from one or more retroreflected optical data signals;
detect a variation in regard to at least one optical beam condition associated with the one or more retroreflected optical data signals, the variation selected from the group consisting of a disruption, a displacement, and a signal strength variation; and
selectively generate a water intrusion event notification message if the variation is detected.

17. The optical data transceiver according to claim 16, further comprising:
a network interface device to facilitate digital data communications between the optical data transceiver and a digital data network in accordance with a data network communication protocol;
wherein the at least one processing element is configured to perform processing operations involving optical signals received by the optical receiver unit and optical signals transmitted by the optical transmitter unit to facilitate wireless network access to the computer data network for a plurality of client devices.

18. The optical data transceiver according to claim 17, wherein the at least one processing element is configured to cause the water intrusion event notification to be communicated to the enterprise monitoring controller using the computer data network.

19. The optical data transceiver according to claim 16, wherein the first data sequence comprises at least a portion of a management frame defined for a predetermined wireless communication protocol.

20. The optical data transceiver according to claim 19, wherein the management frame is a beacon frame.

21. The optical data transceiver according to claim 16, wherein optical receiver unit is a video camera, and the at least one processing element is configured to extract the one or more retro-reflected optical data signals from the video information capture by the video camera.

22. The optical data transceiver according to claim 21, wherein the at least one processing element is configured to detect displacement of the optical beam by comparing a first video image frame captured at a first time to a second video image frame captured at a second time subsequent to the first time.

23. The optical data transceiver according to claim 22, wherein the at least one processing element is configured to compare a first pixel location within the first video image frame where the at least one optical beam is detected at the first time, to a second pixel location within the second video frame where the at least one optical beam is detected at the second time.

24. The optical data transceiver according to claim 16, wherein the optical data signal generated by the optical transmitter unit is comprised of optical radiation having a wavelength in at least one of the visible, infrared or near ultraviolet range.

25. The optical data transceiver according to claim 16, wherein the optical transmitter unit further comprises at least one light emitting diode (LED) which is configured to perform a dual function which includes generating the optical data stream and illuminating the room for human occupants of the monitored space.

26. An optical water intrusion sensing apparatus, comprising:
one or more retroreflectors disposed in a monitored area; and
an optical transceiver including
an optical transmitter unit configured to illuminate at least a portion of the monitored space with an optical data signal which has been modulated to contain a first data sequence,
an optical receiver unit configured to concurrently receive one or more retroreflected optical data signals which have been respectively retroreflected from the one or more reflector elements in response to the optical data signal, and
at least one processing element which is configured to
receive one or more digital data streams extracted respectively from the one or more retroreflected optical data signals,
determine whether the first data sequence is present in tone or more of the retro-reflected optical data signals,
detect a variation in regard to at least one optical beam condition associated with the one or more retroreflected optical data signals, the variation selected from the group consisting of an disruption, a displacement, and a signal strength variation, and
selectively generate a water intrusion event notification message if the variation is detected;
wherein the optical transceiver is configured to function as a wireless network access point, and the optical data signal comprises at least a portion of a management frame defined for a predetermined wireless communication protocol.
